(19) United States
(12) Patent Application Publication
(10) Pub. No.: US 2022/0047038 A1
(43) Pub. Date: Feb. 17, 2022

(54) DANCE TRAINING FOOTWEAR AND RELATED METHODS OF USE FOR DANCE TRAINING

(71) Applicant: Lindsey Kaplowitz, Cary, NC (US)

(72) Inventor: Lindsey Kaplowitz, Cary, NC (US)

(21) Appl. No.: 17/007,484

(22) Filed: Aug. 31, 2020

Related U.S. Application Data
(60) Provisional application No. 63/066,353, filed on Aug. 17, 2020.

(51) Int. Cl. A43B 5/12; A43B 3/00

(52) U.S. Cl. CPC A43B 5/12; A63B 2244/22; A43B 3/0078

(57) ABSTRACT

Dance training footwear and related methods of use for dance training are disclosed herein. According to an aspect, dance training footwear includes a sole and an upper footwear portion attached to the sole. The dance training footwear also includes an instructional object that is attachable to the upper footwear portion. The instructional object has a distinctive appearance for use in being referenced to by a dance instructor for training a dance student.

### CROSS REFERENCE TO RELATED APPLICATION

This application claims priority to U.S. Provisional Patent Application No. 63/066,353, filed Aug. 17, 2020, and titled DANCE TRAINING FOOTWEAR AND RELATED METHODS OF USE FOR DANCE TRAINING, the content of which is incorporated herein by reference in its entirety.

### TECHNICAL FIELD

The presently disclosed subject matter relates generally to dance training. Particularly, the presently disclosed subject matter relates to dance training footwear and related methods of use for dance training.

### BACKGROUND

Dance is a performing art that includes a sequence of various human movements and positions. Example dance types include ballet, tap, jazz, ballroom, contemporary, and hip-hop. To become proficient at a type of dance, much training is usually required. Often, such training begins at a young age and takes place at a dance studio.

Dance training of young dance students can require much repetition of instruction to a student by an instructor. For example, in the case of ballet training, the student will be trained to position his or her foot in various basic positions required of dance. Due to the students' young age, it is often the case that the instructor will need to repeat instruction multiple times, and it can be difficult for the instructor to efficiently convey to the student the exact positioning required of the dance. For at least these reasons, there is a continuing need for improved systems and techniques for facilitating dance training.

Another teaching difficulty arises from students not remembering and needing to hold positioning multiple times prior to muscle memory starting. Thus, the instructor often needs to physically move the dancer's foot and this can be hard in a class setting with many dancers, and especially during a time of social distancing when such training is not appropriate.

For at least the aforementioned reasons, there is a continuing need for improved systems and techniques for facilitating dance training.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a side view of dance training footwear 100 according to embodiments of the present disclosure;

FIGS. 2A and 2B are front perspective views of a pair of ballet shoes that are being worn by a ballet student with the student being positioned in a parallel position (or feet together position) and a first position, respectively; and

FIG. 3 is a front perspective view of a pair of ballet shoes that are being worn by a ballet student with the student being positioned in a passé position.

### SUMMARY

The presently disclosed subject matter relates to dance training footwear and related methods of use for dance training. According to an aspect, dance training footwear includes a sole and an upper footwear portion attached to the sole. The dance training footwear also includes an instructional object that is attachable to the upper footwear portion. The instructional object has a distinctive appearance for use in being referenced to by a dance instructor for training a dance student.

According to another aspect, a method for dance training includes providing dance training footwear. The footwear can include an instructional object attached to a portion thereof. The instructional object has a distinctive appearance for reference to by a dance instructor. Further, the method includes communicating, from the dance instructor to a dance student wearing the dance training footwear, an instruction to move to a position such that the instructional object is viewable to the dance instructor for teaching the dance student a proper dance position.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

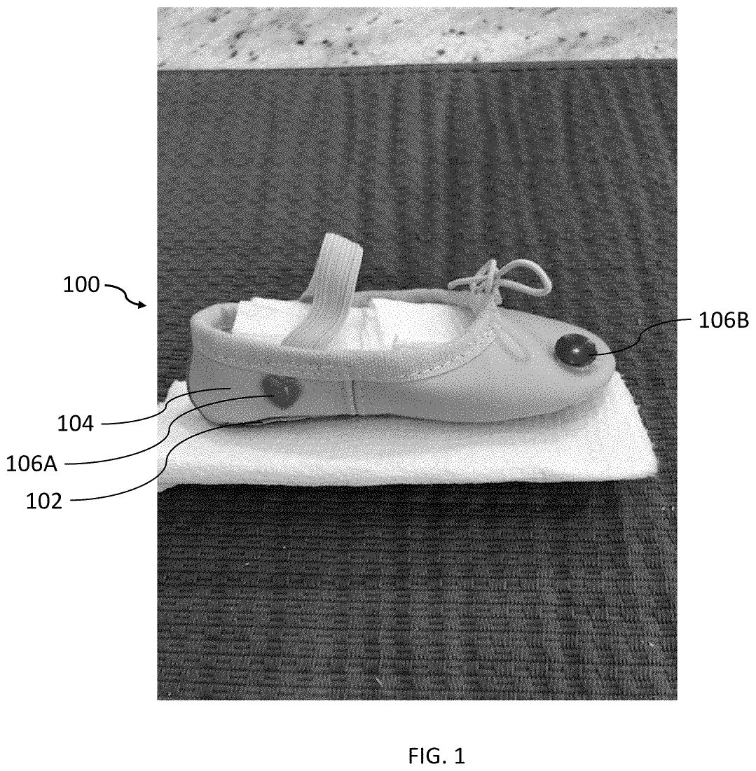

FIG. 1 illustrates a side view of dance training footwear 100 according to embodiments of the present disclosure. In this example, the dance training footwear 100 is ballet shoe (or also referred to as a “ballet slipper”) that is one of a pair of ballet shoes. Only one shoe is shown in the figure for ease of illustration. It should be understood that the other shoe of the pair is a corresponding match of the pair and may include corresponding features of the shoe 100 described herein.

Referring to FIG. 1, the shoe 100 includes a sole 102 and an upper footwear portion 104. The sole 102 and upper footwear portion 104 are attached together by any suitable manner such as by stitching and/or an adhesive. In an example, the upper footwear portion 104 may be folded under and beneath the foot to define at least part of the bottom of the shoe. Further, for example, two separate, left and right front and two separate left and right, rear portions may be attached together to form the shoe and the upper portions are folded under the underside of the shoe. Thus, the front portions are attached to the rear portions at a seam that extends across the shoe.

With continuing reference to FIG. 1, the shoe 100 includes two instructional objects 106A and 106B that are each attachable to different portions of the upper footwear portion 104. The instructional objects 106A and 106B each have distinctive appearances for use in being referenced to by a dance instructor for training a dance student. Example methods of use of the instructional objects 106A and 106B for training a student are described in further detail herein. Although only two instructional objects are shown in this example, it should be understood that any suitable number of instructional objects may be attached to the shoe 100.

Instructional object 106A may be attachable and detachable from the upper footwear portion 104. In this example, the instructional object 106A has an appearance of a heart shape but may be any other recognizable shape for reference by an instructor or student. Further, the instructional object 106A may have any easily recognizable color, such as red or blue, for ease of reference by an instructor or student. Although not shown in this view, the upper footwear portion 104 may be a snap fastener comprising a first portion and a second portion that are interlockable to each other for attachment of the instructional object 106A to the upper footwear portion 104. The first portion can be attached to the upper footwear portion, and the second portion can be attached to the instructional object 106A. As shown, instructional object 106A is positioned at an inner heel portion of the shoe 100.

Instructional object 106B in this example is a printed or “stamped” circular shape near the wearer's toes. Instructional object 106B has a circular shape and may be any suitable color for ease of reference by an instruction or student. Alternatively, the instructional object 106B may be attached to the shoe 100 similar or the same as instructional object 106A.

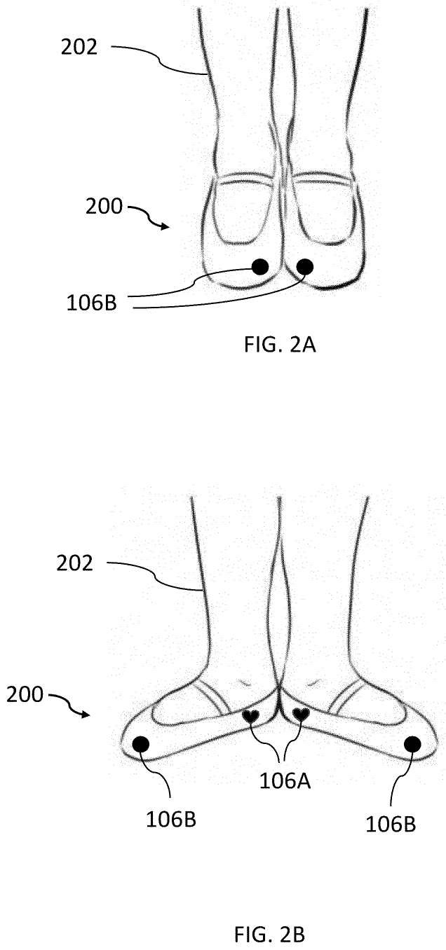

FIGS. 2A and 2B are front perspective views of a pair of ballet shoes, generally designated 200, that are being worn by a ballet student 202 with the student 202 being positioned in a parallel position (or feet together position) and a first position, respectively. Only the legs and feet of the student are shown in the figures for ease of illustration. These figures depict use of shoes having instructional objects 106A and 106B in accordance with embodiments disclosed herein for training the student 202 by an instructor (not shown).

In an example method of use, in FIG. 2A the feet are shown in a parallel position such that the feet are together are parallel to each other. This may be an initial position that a student is in prior to receiving instruction to move to another position. In the parallel position, the instructional objects 106A of each shoe is hidden from view from an instructor positioned in front of the student 202.

While the student is in the parallel position, the instructor may communicate to the student an instruction to move to another position such that the instructional objects 106A are viewable to the instructor for teaching the student a proper dance position. In this example, the instructor communicates an instruction to the student 202 to move to the first position and show the instructional objects 106A (or say “Show your heart charms”). Subsequently, the student can move to the position shown in FIG. 2A, i.e., the first position, such that the instructional objects 106A are viewable to the instructor. In this way, a younger student can be clear about the positioning, because the student can more easily understand that the “first position” means the position when the interior instructional objects 106A are viewable by the instructor.

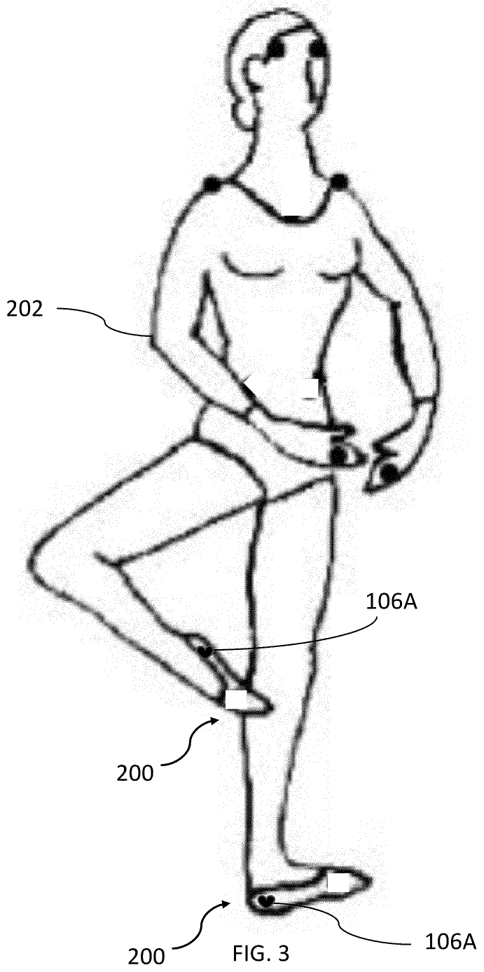

In another example, a ballet instructor may be teaching passé to the ballet student. In this example, the instructor can instruct the student to place a charm or other instructional object on the toe such that you just see the opposite kneecap and show the instructional object 106A of the inner heel of the foot of the leg in passé at the same time. FIG. 3 illustrates a front perspective view of a pair of ballet shoes, generally designated 200, that are being worn by a ballet student 202 with the student 202 being positioned in a passé position.

In another example, a ballet instructor may be teaching tendu to the ballet student. In this example, the toe charm or instructional object is positioned out in front on the ground with leg straight and heel shape so everyone can see it. This helps the student to find turnout which is essential in ballet.

In another example, a ballet instructor may be teaching battemant to the ballet student. This is similar to the above for tendu except that the leg is in air.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. Dance training footwear comprising:
a sole;
an upper footwear portion attached to the sole; and
an instructional object that is attachable to the upper footwear portion, wherein the instructional object has a distinctive appearance for use in being referenced to by a dance instructor for training a dance student.

2. The dance training footwear of claim 1, further comprising a snap fastener comprising a first portion and a second portion that are interlockable to each other for attachment of the instructional object to the upper footwear portion, wherein the first portion is attached to the upper footwear portion, and wherein the second portion is attached to the instructional object.

3. The dance training footwear of claim 1, wherein the instructional object is attached to an inner portion of the upper footwear portion.

4. The dance training footwear of claim 1, wherein the upper footwear portion comprises an inner portion, and wherein the instructional object is attached to the inner portion.

5. The dance training footwear of claim 1, wherein the instructional object comprises a decorative charm.

6. The dance training footwear of claim 1, wherein the instructional object is attached to an area of the upper footwear portion such that the instructional object is viewable to a dance instructor when a wearer of the dance training footwear has a foot wearing the dance training footwear in a proper dance position.

7. The dance training footwear of claim 6, wherein the dance position is a ballet first, second, third, fourth, fifth positions, a passé position, a tendu position, or a battement position.

8. A method for dance training, the method comprising:
providing dance training footwear comprising an instructional object attached to a portion thereof, wherein the instructional object has a distinctive appearance for reference to by a dance instructor; and
communicating, from the dance instructor to a dance student wearing the dance training footwear, an instruction to move to a position such that the instructional object is viewable to the dance instructor for teaching the dance student a proper dance position.

9. The method of claim 8, wherein the dance training footwear comprises:
a sole; and
an upper footwear portion attached to the sole, and
wherein the instructional object is attachable to the upper footwear portion.

10. The method of claim 9, wherein the dance training footwear further comprises a snap fastener comprising a first portion and a second portion that are interlockable to each other for attachment of the instructional object to the upper footwear portion, wherein the first portion is attached to the upper footwear portion, and wherein the second portion is attached to the instructional object.

11. The method of claim 8, wherein the instructional object is attached to an inner portion of the upper footwear portion.

12. The method of claim 8, wherein the upper footwear portion comprises an inner portion, and wherein the instructional object is attached to the inner portion.

13. The method of claim 1, wherein the instructional object comprises a decorative charm.

14. The method of claim 8, wherein the instructional object is attached to an area of the upper footwear portion such that the instructional object is viewable to a dance instructor when a wearer of the dance training footwear has a foot wearing the dance training footwear in a proper dance position.

15. The method of claim 14, wherein the dance position is a ballet first, second, third, fourth and fifth positions, a passé position, a tendu position, or a battement position.
